(19) United States
(12) Patent Application Publication
(10) Pub. No.: US 2023/0385604 A1
(43) Pub. Date: Nov. 30, 2023

(54) PREDICTING WELL PERFORMANCE USING NEURAL NETWORKS

(71) Applicant: ARAMCO SERVICES COMPANY, Houston, TX (US)

(72) Inventors: Hui-Hai Liu, Katy, TX (US); Jilin Jay Zhang, Houston, TX (US); Jodel Cornelio, Houston, TX (US); Syamil Mohd-Razak, Houston, TX (US)

(73) Assignee: ARAMCO SERVICES COMPANY, Houston, TX (US)

(21) Appl. No.: 17/664,961

(22) Filed: May 25, 2022

(51) Int. Cl. G06N 3/04; G06N 3/08; G01V 1/28

(52) U.S. Cl. CPC G06N 3/0454; G06N 3/0481; G06N 3/084; G01V 1/282

(57) ABSTRACT

A system and methods for predicting well performance are disclosed. The method includes obtaining first geoscience data and first performance data, obtaining second geoscience data and second performance data, and obtaining new geoscience data for a new well. The method further includes training a first neural network and determining predicted second performance data using the first neural network. The method still further includes determining a residual between the second performance data and the predicted second performance data and training a second neural network. The method still further includes determining predicted new performance data for the new well by inputting a subset of the new geoscience data into the first neural network, determining a new residual for the new well by inputting the new geoscience data into the second neural network, and updating the predicted new performance data using the new residual.

### BACKGROUND

In the oil and gas industry, a vast amount of geoscience data is collected prior to and during the development of a hydrocarbon field. Geoscience data may include geological, petrophysical, and completion data. However, hydrocarbon field management may still be challenging as it may be difficult to assess how prolific hydrocarbon fields will be prior to hydrocarbon recovery. As such, it may be advantageous to predict hydrocarbon recovery for wells within a hydrocarbon field using the previously collected geoscience data.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to methods for predicting well performance. The method includes obtaining first geoscience data and first performance data, obtaining second geoscience data and second performance data, and obtaining new geoscience data for a new well. The method further includes training a first neural network and determining predicted second performance data using the first neural network. The method still further includes determining a residual between the second performance data and the predicted second performance data and training a second neural network. The method still further includes determining predicted new performance data for the new well by inputting a subset of the new geoscience data into the first neural network, determining a new residual for the new well by inputting the new geoscience data into the second neural network, and updating the predicted new performance data using the new residual.

In general, in one aspect, embodiments relate to a non-transitory computer readable medium storing instructions executable by a computer processor. The instructions include functionality for receiving first geoscience data and first performance data, receiving second geoscience data and second performance data, and receiving new geoscience data for a new well. The instructions further include training a first neural network and determining predicted second performance data using the first neural network. The instructions still further include determining a residual between the second performance data and the predicted second performance data and training a second neural network. The instructions still further include determining predicted new performance data for the new well by inputting a subset of the new geoscience data into the first neural network, determining a new residual for the new well by inputting the new geoscience data into the second neural network, and updating the predicted new performance data using the new residual.

In general, in one aspect, embodiments relate to a system including a seismic survey system, a logging system, a rock core drill bit, and a computer system configured to receive first geoscience data and first performance data, receive second geoscience data and second performance data, and receive new geoscience data for a new well. The computer system is further configured to train a first neural network and determine predicted second performance data using the first neural network. The computer system is still further configured to determine a residual between the second performance data and the predicted second performance data and train a second neural network. The computer system is still further configured to determine predicted new performance data for the new well by inputting a subset of the new geoscience data into the first neural network, determine a new residual for the new well by inputting the new geoscience data into the second neural network, and update the predicted new performance data using the new residual.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a subterranean region in accordance with one or more embodiments.

FIG. 2 depicts a well in accordance with one or more embodiments.

FIG. 3 illustrates a neural network in accordance with one or more embodiments.

FIG. 4A shows a block diagram in accordance with one or more embodiments.

FIG. 4B shows a block diagram in accordance with one or more embodiments.

FIG. 5 shows a flowchart in accordance with one or more embodiments.

FIG. 6 show a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to a “hydrocarbon field” includes reference to one or more of such fields.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

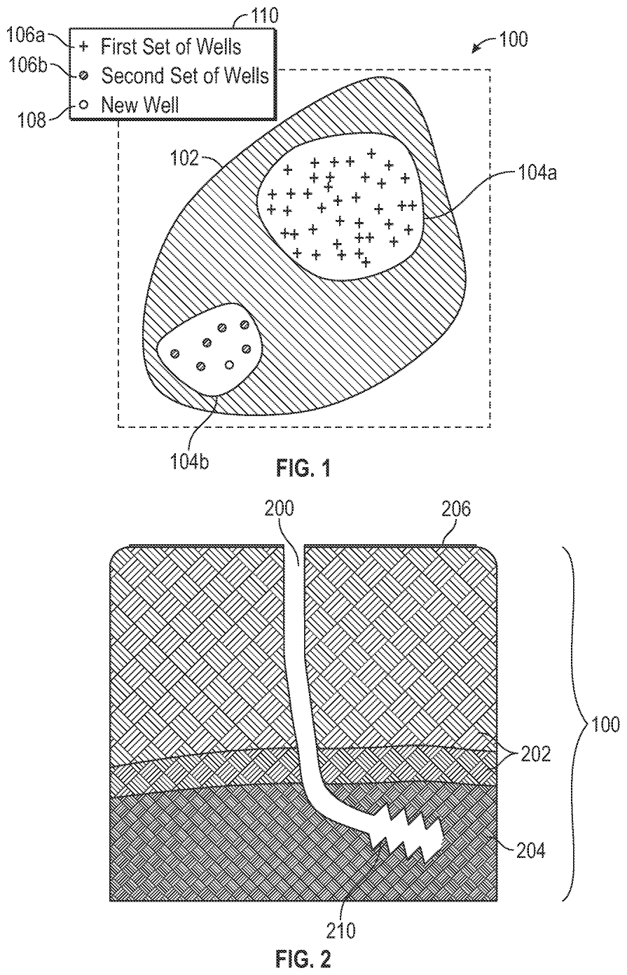

In the following description of FIGS. 1-6, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Predicting the performance of wells within a hydrocarbon field may be imperative to appropriately manage the resources associated with recovering hydrocarbons from a hydrocarbon field. Neural networks may be useful tools to predict hydrocarbon field performance to aid in determining a hydrocarbon field management plan. Large training data sets may be useful to create robust neural networks that model the training data well and provide accurate predictions of complex hydrocarbon fields, such as hydrocarbon fields of unconventional hydrocarbon reservoirs.

FIG. 1 depicts a top-down view of a subterranean region (100) in accordance with one or more embodiments. A sedimentary basin (102) may exist within the subterranean region (100). The sedimentary basin (102) may contain hydrocarbon fields (104a, b) where hydrocarbons accumulate to form hydrocarbon reservoirs. Each hydrocarbon reservoir may be considered either conventional or unconventional. Conventional hydrocarbon reservoirs contain crude oil or natural gas trapped within geological traps such as faults, salt domes, and anticlines and/or trapped beneath low permeability cap rock. Alternatively, unconventional hydrocarbon reservoirs contain source rocks (i.e., rock rich in organic matter) with low permeability that inherently generates, houses, and contains hydrocarbons.

A hydrocarbon field (104a, 104b) may be in one of five phases of the hydrocarbon field lifecycle: exploration, appraisal, development, production, and abandonment. In the exploration phase, the aim is to identify the location of hydrocarbons. Seismic surveys may be used to determine geological structures within a subterranean region (100) that have a high likelihood of trapping hydrocarbons. Seismic surveys may also be used to determine seismic attributes that indicate the presence of hydrocarbons within the traps and velocity models of the subterranean region (100). Hereinafter any data types acquired from a seismic survey will be denoted “seismic data”.

If seismic surveys indicate the existence of hydrocarbons, exploration wells may be drilled within a hydrocarbon field (104a, 104b) that ideally access those hydrocarbons. During and after drilling, well log data may be recorded and rock core samples may be collected. Types of rocks and volumes of fluids present in specific geological structures may be estimated from well log data interpretations and rock core sample measurements. These estimates may be combined with geological structures to initially characterize the subterranean region (100). Hereinafter seismic data and well log data will be collectively referred to as geological data. Data types within well log data may include, without limitation, resistivity logs, gamma ray logs, density logs, and neutron porosity logs. The interpretation of types of rocks and volumes of fluids from well log data may be data types within petrophysical data. Further, hereinafter any data types measured from rock core samples, such as porosity, permeability, saturation, and total carbon content, will be collectively referred to as petrophysical data. Geological data and petrophysical data may be used to predict well performance data (hereinafter also “performance data”) or how prolific a well will be at producing hydrocarbons to the surface. Types of performance data may include initial production rates, production decline rates, bottom-hole pressure decline, the cumulative production from the well over a time window, and the estimate ultimate recovery (EUR) of a well, which is the cumulative amount of hydrocarbons produced during the lifetime of a well.

Once hydrocarbons are identified and characterized, the hydrocarbon field (104a, 104b) may enter the appraisal phase. Additional geological data and petrophysical data may be acquired from seismic surveys, exploration and appraisal wells, and/or rock core samples and these data interpreted to gain confidence in the existence of prolific hydrocarbons. The boundaries of a hydrocarbon reservoir may also be determined. Further, the predicted performance data may be refined.

The development phase aims to produce the identified and characterized hydrocarbons. Development wells are drilled. Additional geological data and petrophysical data may be collected. Field development plans are finalized and realized. Infrastructure to support the hydrocarbon field (104a, 104b) is built. For completed development wells, completion data may also be collected. Hereinafter completion data may include the number of fracture stages, the number of fracture clusters per stage, the amount of proppant per foot along a well, and the amount of fracturing fluid per foot along a well. Predicted performance data may be further refined and initially measured during the development phase as hydrocarbons are produced from the completed wells.

The development phase and the production phase often overlap. In the production phase, wells continue to be drilled and hydrocarbons continue to be produced and sold to market. Hereinafter, the hydrocarbon field 104a may be considered a producing hydrocarbon field. Production wells will be drilled to create a first set of wells (106a) within the producing hydrocarbon field (104a) as shown by the key (110). Injector wells may also be drilled. Additional geological, petrophysical, completion, and performance data may be acquired for each production well. Hereinafter, geological, petrophysical and completion data will be collectively referred to as geoscience data.

A producing hydrocarbon field (104a) may enter abandonment or decommissioning when it no longer yields enough hydrocarbons to be cost-effective. Production wells and injector wells will be plugged. Production facilities will be dismantled.

If a producing hydrocarbon field (104a) proves prolific and cost-effective, neighboring hydrocarbon fields (104b) may enter or progress in the hydrocarbon field lifecycle to create a second set of wells (106b) as shown by the key (110). As new wells (108) within the hydrocarbon field (104b) are drilled, geoscience data may be acquired, interpreted, and/or measured. Additional data types within geoscience data may be included for some wells within the second set of wells (106b) and the new well (108) due to advancements in the oil and gas industry and/or in technology. For example, resistivity logs, one type of geoscience data, from array induction tools may have been collected for the second set of wells (106b) and the new well (108) but not the first set of wells (106a). Performance data may also be measured for each well within the second set of wells (106b). Further, performance data may be predicted for each new well (108).

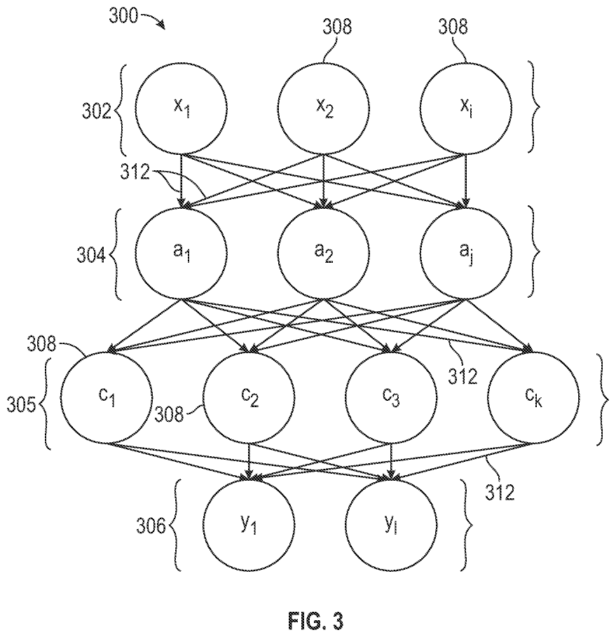

FIG. 2 depicts a well (200) within the subterranean region (100) from FIG. 1 in accordance with one or more embodiments. The well (200) may traverse various rock formations (202) to ultimately penetrate a hydrocarbon reservoir (204). The well (200) may penetrate a conventional or an unconventional hydrocarbon reservoir (204) and produce hydrocarbons from either type of reservoir to the surface (206). A plurality of well tools placed on the surface (206) and/or into the well (200) may be used at various stages of the hydrocarbon field lifecycle.

Prior to drilling a well (200), a seismic survey may be performed over the subterranean region (100) to determine geological data. Once a hydrocarbon reservoir (204) is located and characterized, a well (200) may be drilled. The well (200) may be drilled using a bottom hole assembly (BHA) that may include, at least in part, a rock core drill bit and logging-while-drilling tools. The rock core drill bit may collect rock core samples during drilling that may be used to determine well log data and/or petrophysical data. Logging-while-drilling tools may collect well log data and/or petrophysical data during drilling. Once the well (200) is drilled, wireline logging tools may collect additional geological data. A well (200) may then be completed in preparation for production, such as by inducing hydraulic fractures (210). Completion data may be determined by petroleum engineers prior to and during completion operations. Following completion, a production tree may be attached to the wellhead on the surface (206) to control well pressure and the rate of hydrocarbon production. Performance data may be collected by sensors within the production tree.

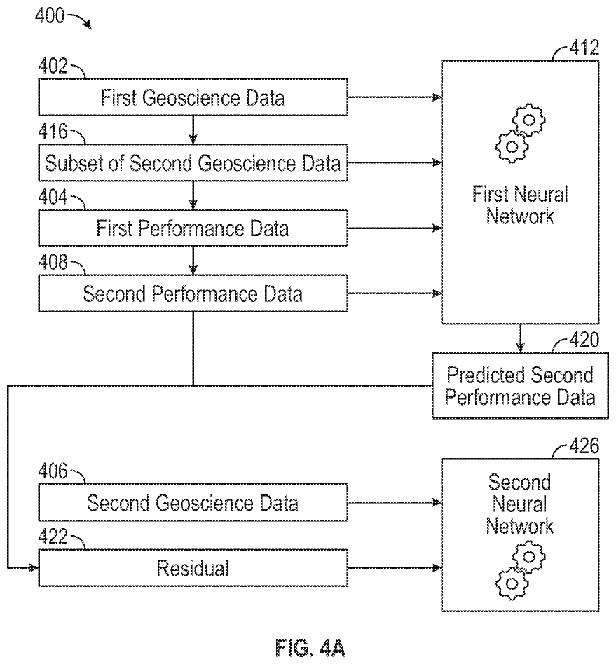

FIG. 3 illustrates an artificial neural network (300) (hereinafter also “neural network”) in accordance with one or more embodiments. A neural network (300) uses a series of mathematical functions to make predictions based on observations. A neural network (300) may include an input layer (302), hidden layers such as a first hidden layer (304) and a second hidden layer (305), and an output layer (306). Each layer represents a vector where each element within each vector is represented by an artificial neuron (308) (hereinafter also “neuron”). An artificial neuron (308) is loosely based on a biological neuron of the human brain. The input layer (302) may represent the vector x where each neuron (308) within the input layer (302) represents each element xᵢ within x. Each element is a value that represents a data type that is empirical or observed. The vector x may be denoted “input data” and, in some embodiments, may be geoscience data. FIG. 3 displays the input data or vector x as three elements x₁, x₂, and xᵢ, where x₁ may be a value that represents porosity, x₂ may be a value that represents permeability, and xᵢ may be a value that represents a seismic attribute. In this embodiment, the data types are porosity, permeability, and a seismic attribute.

The output layer (306) may represent the vector y where each neuron (308) within the output layer (306) represents each element yₗ within y. The vector y may be denoted “output data” and, in some embodiments, may be performance data. FIG. 3 displays the output data or vector y as two elements y₁ and yₗ where y₁ may be a value that represents EUR and yₗ may be a value that represents production decline rates. In this embodiment, the data types are EUR and production decline rates. Further to this embodiment, the output data is numeric and, thus, the neural network (300) is being used to solve a regression problem. In other embodiments, the output data may be categorical in which case the neural network (300) is being used to solve a classification problem.

Neurons in the input layer (302) may be connected to neurons in the first hidden layer (304) through connections (312). A connection (312) may be analogous to a synapse of the human brain and may have a weight associated to it. The weights for all connections (312) between the input layer (302) and the first hidden layer (304) make up a first array of weights w^{[1]} with elements wᵢⱼ where:

$${w}^{[ 1 ]} = [ \begin{matrix}{w}_{11} & {w}_{12} & {w}_{13} \\ {w}_{21} & {w}_{22} & {w}_{23} \\ {w}_{31} & {w}_{32} & {w}_{33}\end{matrix} ] , \qquad Equation ( 1 )$$

for the embodiment shown in FIG. 3. The elements wᵢⱼ in each column are the weights associated with the connections (312) between each of the three elements in vector x that propagate to the same neuron (308) in the first hidden layer (304). The vector x and the first array of weights w^{[1]} may be multiplied together, the bias terms b^{[1]} added, if applicable, and scaled by the activation function g^{[1]} to determine the vector a where each element aⱼ may be a value represented by a neuron (308) in the first hidden layer (304) such that:

aⱼ=gⱼ(bⱼ+Σᵢxᵢwᵢⱼ). Equation (2)

Each weight wᵢⱼ within the first array of weights w^{[1]} may amplify or reduce the significance of each element xᵢ within vector x. The bias terms b^{[1]} shift the vector x and the activation function g^{[1]} determines the amplitude of the weighted summation. The activation function g^{[1]} may be, without limitation, an identity function, a logistic function, a sigmoid function, a hyperbolic tangent function, a Gaussian error linear unit (GELU) function, a softplus function, a Gaussian function, a shifted quadratic unit (SQU) function, and a decaying sine unit function. The activation function selected may depend, at least in part, on if the neural network (300) is being used to solve a regression problem or a classification problem.

Similarly, the weights for all connections (312) between the first hidden layer (304) and the second hidden layer (305) make up a second array of weights w^{[2]}. The vector a and the second array of weights w^{[2]} may be multiplied together, the bias terms b^{[2]} added, if applicable, and scaled by the activation function g^{[2]} to determine the vector c where each element cₖ is a value represented with a neuron (308) in the second hidden layer (304) such that:

cₖ=gₖ(bₖ+Σⱼaⱼwⱼₖ). Equation (3)

Continuing with the embodiment of FIG. 3, the weights for all connections (312) between the second hidden layer (305) and the output layer (306) make up a third array of weights w^{[3]}. The vector c and the third array of weights w^{[3]} may be multiplied together, the bias terms b^{[3]} added, if applicable, and scaled by the activation function g^{[3]} to determine the vector y. A person of ordinary skill in the art will appreciate that FIG. 3 depicts one highly simplified version of the action of a neural network (300).

For a neural network (300) to complete a “task” of predicting output data from observed input data, the neural network (300) must first be trained. Training may be defined as the process of determining the values of the weights within each array of weights and the values of each bias term such that the neural network (300) makes accurate predictions. Training may be performed iteratively, where each iteration is referred to as an “epoch”, using training data and backpropagation. The training data may be a plurality of input data and a plurality of output data both of which are observed. Assume a plurality of vectors x^{[n]} and a plurality of vectors y′^{[n]} collectively make up the training data. Backpropagation is defined as using a gradient descent algorithm to update the weights and bias terms within a neural network (300). Gradient descent algorithms may include, without limitation, stochastic gradient descent, batch gradient descent, Momentum gradient descent, Adadelta gradient descent, Adam gradient descent, and Nadam gradient descent.

Prior to training a neural network, the weights within all arrays of weights and the bias terms may be initialized as small, random values. During training, the input data within a batch of training data, such as x^{[1]} through x^{[5]}, may be input into the neural network (300) to predict y^{[1]} through y^{[5]}. The predicted vectors y^{[1]} through y^{[5]} are then compared to the output data within the batch of training data y′^{[1]} through y′^{[5]} using a residual function R. The residual function R may also be referred to as an objective function, a cost function, a loss function, or an error function. In some embodiments, the residual function R may be the sum of the squared errors such that:

R=½Σₙ₌₁⁵(yₚ^{[n]}−y′ₚ^{[n]})² .Equation (4)

The gradient of the residual function R with respect to each of the weights may then be determined and used by a gradient descent algorithm to adjust each weight and each bias term in the proper direction. Additional epochs using a plurality of batches within the training data may be performed. In some embodiments, a neural network may be considered adequately trained once the residual function R for all training data reaches a threshold or once a pre-defined number of epochs have been performed.

Following training, the neural network (300) may perform a task where the vector x^{[1]}, a part of the training data, is input into the neural network (300) to predict the vector y^{[1]} where the residual between y^{[1]} and y′^{[1]} should be negligible. The neural network (300) may also perform a new task where a vector x^{[6]}, not a part of the training data, is input into the neural network (300) to predict the vector y^{[6]} where y′^{[6]} is unknown.

A neural network (300) may not be immediately suitable when the input data for a new task contains different data types and/or has a different dimensionality than the input data within the training data. For example, assume the input data for a new task is the vector x=[x₂, x₃, x₄, x₅] and that vector is input into the neural network (300) shown in FIG. 3. Further, assume the subscripts 1 through 5 are each specific data types. When the vector x=[x₂, x₃, x₄, x₅] for the new task is input into the neural network (300) shown in FIG. 3, the data types may be represented by the wrong neurons (308) in the input layer (302). The element x₂ within x=[x₂, x₃, x₄, x₅] may be represented by the left-most neuron (308) in the input layer (302), the element x₃, the center neuron (308) in the input layer (302), and the element x₄, the right-most neuron (308) in the input layer (302). The neural network (300) may then inaccurately predict the output data because the neural network (300) is trained for different data types to be represented by different neurons (308) in the input layer (302). Further, the element x₅ may not be represented by a neuron (308) in the input layer (302) and thus has no connection (312) to neurons (308) in the first hidden layer (304). The element x₅ then cannot be used to enhance the output data predicted by the neural network (300).

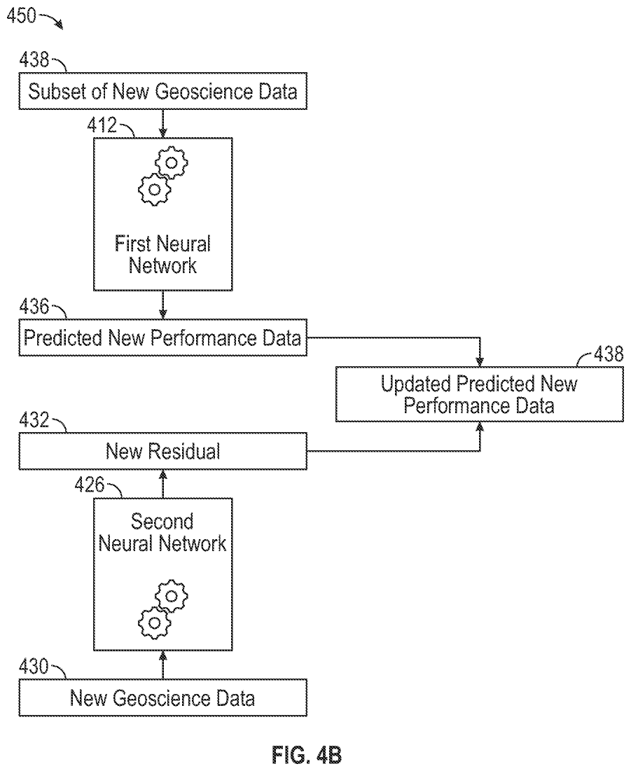

FIG. 4A illustrates a first block diagram (400) of how to train two neural networks to later predict well performance data. Both the first neural network (412) and the second neural network (426) may be designed as described in FIG. 3. As such, the first neural network (412) and the second neural network (426) may each be an artificial neural network (300). If multiple hidden layers (304) exist in either neural network, that neural network may be considered a deep neural network. The design of the first neural network (412) and the design of the second neural network (426) may each include the number of layers within each neural network, the number of neurons (308) within each layer, where bias terms are included, and what activation functions are used.

The first neural network (412) is trained using first geoscience data (402) and first performance data (404) for a first set of wells (106a) and using a subset of second geoscience data (416) and second performance data (408) for a second set of wells (106b). The first geoscience data (402) includes a first set of data types. The second geoscience data (406) includes a second set of data types. The subset of second geoscience data (416) includes, at least, the first set of data types and is denoted the subset of the second set of data types. If the subset of the second set of data types includes additional data types not in the first set of data types, the first neural network (412) will not use the additional data types during training or prediction. For example, in some embodiments, the first set of data types for the first geoscience data (402) and the subset of the second set of data types for the subset of second geoscience data (416) may both be the same four seismic attributes and porosity. In other embodiments, the subset of the second set of data types may be the same four seismic attributes, porosity, and permeability where the first neural network (412) will not use permeability. The first performance data (404) and the second performance data (408) may also include a plurality of data types such as cumulative hydrocarbon production over a time window and EUR. The first neural network (412) will not use data types that are not in both the first performance data (404) and the second performance data (408).

Predicted second performance data (420) is then output from the trained first neural network (412). The predicted second performance data (420) is compared to the second performance data (408) to determine at least one residual (422). In some embodiments, the residual (422) may be the difference between the EUR of the predicted second performance data (420) and the EUR of the second performance data (408) for a batch of training data or the residual (422) may be the square of the difference between the EUR of the predicted second performance data (420) and the EUR of the second performance data (408) for all of the training data.

The second neural network (426) is trained using the second geoscience data (406) for the second set of wells (106b) and the residual (422). The second geoscience data (406) includes the second set of data types. The second set of data types may include different data types compared to the first set of data types. If the second set of data types includes additional data types not in the first set of data types, the second neural network (426) will include the additional data types for training and prediction. For example, in one embodiment, the first set of data types may include two seismic attributes, porosity, permeability, and the number of fracture clusters per stage while the second set of data types may include the same two seismic attributes, porosity, permeability, water saturation, the number of fracture clusters per stage, and the amount of proppant per foot along the depth of the well. The second neural network (426) may then include water saturation and the amount of proppant per foot along the depth of the well.

FIG. 4B illustrates a second block diagram (450) describing the use of two trained neural networks to predict well performance data. A subset of new geoscience data (438) for a new well (108) may be input into the trained first neural network (412) to determine predicted new performance data (436). The new geoscience data (430) for the new well (108) may be input into the trained second neural network (426) to determine a new residual (432). The predicted new performance data (436) output from the trained first neural network (412) may be updated using the new residual (432) output from the trained second neural network (426) to determine the updated predicted new performance data (438) for the new well (108). In some embodiments, each data type of the predicted new performance data (436) and the new residual (432) are summed to determine the updated predicted new performance data (438). In other embodiments, a regularization term may be further summed with each data type of the predicted new performance data (436) and the new residual (432) to determine the updated predicted new performance data (438).

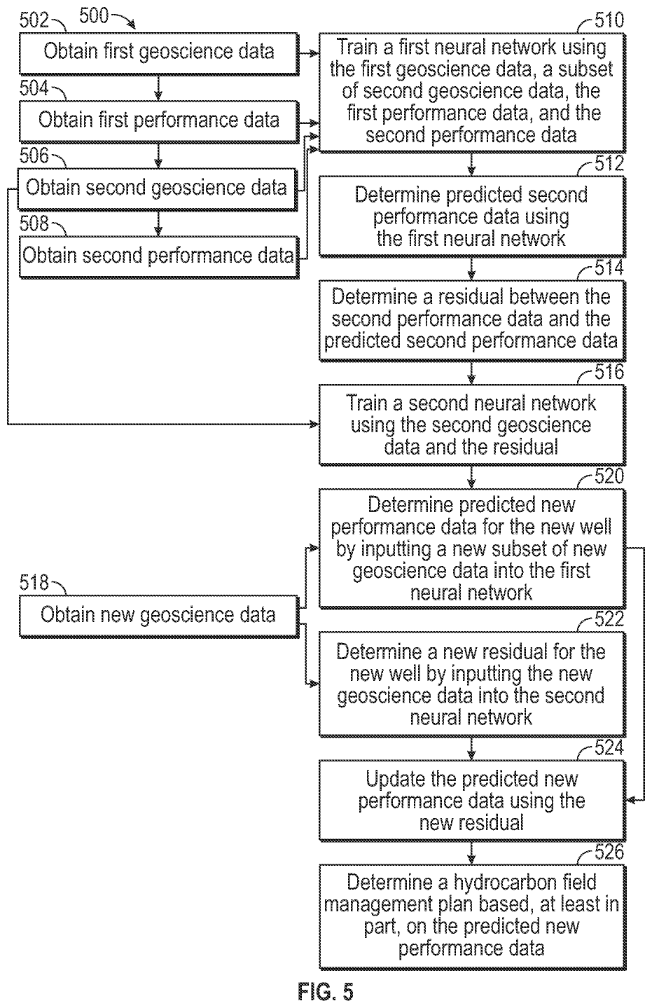

FIG. 5 shows a flowchart (500) in accordance with one or more embodiments.

In steps 502 and 504, first geoscience data (402) and first performance data (404) are obtained for a first set of wells (106a). The first geoscience data (402) may include geological, petrophysical, and completion data. The first geoscience data (402) includes a first set of data types where the data types are particular geological, petrophysical, and completion data.

In steps 506 and 508, second geoscience data (406) and second performance data (408) are obtained for a second set of wells (106b). The second geoscience data (406) may include geological, petrophysical, and completion data. The second geoscience data (406) includes a second set of data types where the data types are particular geological, petrophysical, and completion data.

In step 510, a first neural network (412) is trained. The training data includes the data types that are common to both the first geoscience data (402) and the subset of the second geoscience data (416) and the data types that are common to both the first performance data (404) and the second performance data (408). The first neural network (412) may include an input layer (302), hidden layers, and an output layer (306) where each layer may include a plurality of neurons (308). Further, bias terms and activation functions may be defined. During training, the weights within all arrays of weights and the bias terms are determined. In some embodiments, training the first neural network (412) may include training the first neural network (412) using the first geoscience data (402) and the first performance data (404) followed by re-training the first neural network (412) using the subset of the second geoscience data (416) and the second performance data (408). Re-training may use a transfer learning approach. Transfer learning is defined as re-training a subset of weights within the arrays of weights and a subset of the bias terms within a trained neural network (300). Similar to training, re-training may be performed iteratively using training data and backpropagation.

In step 512, predicted second performance data (420) is output from the trained first neural network (412). In step 514, a residual (422) is determined between the second performance data (408) and the predicted second performance data (420). In some embodiments, the residual (422) may be the difference between the second performance data (408) and the predicted second performance data (420) for a batch of the training data or the square of the difference between the second performance data (408) and the predicted second performance data (420) for all the training data.

In step 516, the second geoscience data (406) and the residual (422) are used to train a second neural network (426). The second neural network (426) may be made up of an input layer (302), hidden layers, and an output layer (306) where each layer may include a plurality of neurons (308). Further, bias terms and activation functions may be defined. During training, the weights within all arrays of weights and the bias terms are determined.

In step 518, new geoscience data (430) are obtained for a new well (108). The new geoscience data (430) includes a new set of data types where the data types are particular geological, petrophysical, and completion data.

In step 520, a subset of the new geoscience data (438) is input into the first neural network (412) to determine predicted new performance data (436). If the subset of the new set of data types includes additional data types not in the first set of data types, the first neural network (412) will not use the additional data types.

In step 522, the new geoscience data (430) is input into the second neural network (426) to determine a new residual (432). If the new set of data types includes additional data types not in the second set of data types, the second neural network (426) will not use the additional data types.

In step 524, the predicted new performance data (436) output from the first neural network (412) and the new residual (432) output from the second neural network (426) are combined to determine the updated predicted new performance data (438) for the new well (108).

In step 526, the updated predicted new performance data (438) may then be used, at least in part, to determine a hydrocarbon field management plan to further hydrocarbon recovery within a hydrocarbon field (104b). A hydrocarbon field management plan may include when and where to drill new wells (108) and/or injection wells. A hydrocarbon field management plan may also include what geoscience data to acquire and when to acquire the geoscience data. A hydrocarbon field management plan may further include how to complete the newly drilled wells (108) in preparation for production, such as what casing to use and if hydraulic fractures should be induced. When, where, and how to stimulate wells to restore or enhance hydrocarbon recovery within a hydrocarbon field (104b) may also be a part of a hydrocarbon field management plan. Determining the production infrastructure, such as the size of the midstream and downstream facilities, may also be a part of the hydrocarbon field management plan. Models of sedimentary basins, which may use the updated predicted new performance data (438), may also be built and updated to provide an accurate representation of the current state of the hydrocarbon field (104a, b) and future states of the hydrocarbon field (104a, b).

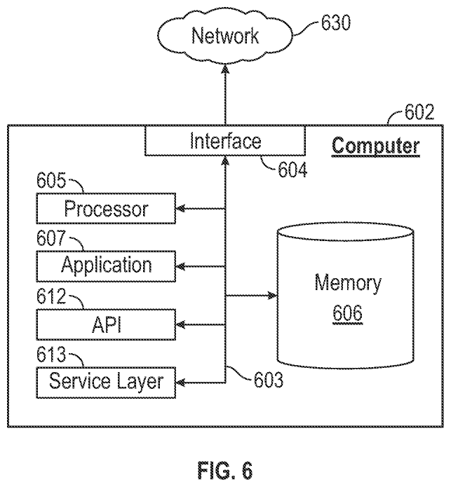

FIG. 6 depicts a block diagram of a computer system (602) used to provide computational functionalities associated with described machine learning networks, algorithms, methods, functions, processes, flows, and procedures as described in this disclosure, according to one or more embodiments. The illustrated computer (602) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (602) may include a computer that includes an input device, such as a keypad, keyboard, touch screen, or other device that can accept user information, and an output device that conveys information associated with the operation of the computer (602), including digital data, visual, or audio information (or a combination of information), or a GUI.

The computer (602) can serve in a role as a client, network component, a server, a database or other persistency, or any other component (or a combination of roles) of a computer system for performing the subject matter described in the instant disclosure. The illustrated computer (602) is communicably coupled with a network (630). In some implementations, one or more components of the computer (602) may be configured to operate within environments, including cloud-computing-based, local, global, or other environment (or a combination of environments).

At a high level, the computer (602) is an electronic computing device operable to receive, transmit, process, store, or manage data and information associated with the described subject matter. According to some implementations, the computer (602) may also include or be communicably coupled with an application server, e-mail server, web server, caching server, streaming data server, business intelligence (BI) server, or other server (or a combination of servers).

The computer (602) can receive requests over network (630) from a client application (for example, executing on another computer (602)) and responding to the received requests by processing the said requests in an appropriate software application. In addition, requests may also be sent to the computer (602) from internal users (for example, from a command console or by other appropriate access method), external or third-parties, other automated applications, as well as any other appropriate entities, individuals, systems, or computers.

Each of the components of the computer (602) can communicate using a system bus (603). In some implementations, any or all of the components of the computer (602), both hardware or software (or a combination of hardware and software), may interface with each other or the interface (604) (or a combination of both) over the system bus (603) using an application programming interface (API) (612) or a service layer (613) (or a combination of the API (612) and service layer (613). The API (612) may include specifications for routines, data structures, and object classes. The API (612) may be either computer-language independent or dependent and refer to a complete interface, a single function, or even a set of APIs. The service layer (613) provides software services to the computer (602) or other components (whether or not illustrated) that are communicably coupled to the computer (602). The functionality of the computer (602) may be accessible for all service consumers using this service layer. Software services, such as those provided by the service layer (613), provide reusable, defined business functionalities through a defined interface. For example, the interface may be software written in JAVA, C++, or other suitable language providing data in extensible markup language (XML) format or another suitable format. While illustrated as an integrated component of the computer (602), alternative implementations may illustrate the API (612) or the service layer (613) as stand-alone components in relation to other components of the computer (602) or other components (whether or not illustrated) that are communicably coupled to the computer (602). Moreover, any or all parts of the API (612) or the service layer (613) may be implemented as child or sub-modules of another software module, enterprise application, or hardware module without departing from the scope of this disclosure.

The computer (602) includes an interface (604). Although illustrated as a single interface (604) in FIG. 6, two or more interfaces (604) may be used according to particular needs, desires, or particular implementations of the computer (602). The interface (604) is used by the computer (602) for communicating with other systems in a distributed environment that are connected to the network (630). Generally, the interface (604) includes logic encoded in software or hardware (or a combination of software and hardware) and operable to communicate with the network (630). More specifically, the interface (604) may include software supporting one or more communication protocols, such as the Wellsite Information Transfer Specification (WITS) protocol, associated with communications such that the network (630) or interface's hardware is operable to communicate physical signals within and outside of the illustrated computer (602).

The computer (602) includes at least one computer processor (605). Although illustrated as a single computer processor (605) in FIG. 6, two or more processors may be used according to particular needs, desires, or particular implementations of the computer (602). Generally, the computer processor (605) executes instructions and manipulates data to perform the operations of the computer (602) and any algorithms, methods, functions, processes, flows, and procedures as described in the instant disclosure.

The computer (602) also includes a memory (606) that holds data for the computer (602) or other components (or a combination of both) that can be connected to the network (630). For example, memory (606) can be a database storing data consistent with this disclosure. Although illustrated as a single memory (606) in FIG. 6, two or more memories may be used according to particular needs, desires, or particular implementations of the computer (602) and the described functionality. While memory (606) is illustrated as an integral component of the computer (602), in alternative implementations, memory (606) can be external to the computer (602).

The application (607) is an algorithmic software engine providing functionality according to particular needs, desires, or particular implementations of the computer (602), particularly with respect to functionality described in this disclosure. For example, application (607) can serve as one or more components, modules, applications, etc. Further, although illustrated as a single application (607), the application (607) may be implemented as multiple applications (607) on the computer (602). In addition, although illustrated as integral to the computer (602), in alternative implementations, the application (607) can be external to the computer (602).

There may be any number of computers (602) associated with, or external to, a computer system containing a computer (602), wherein each computer (602) communicates over network (630). Further, the term “client,” “user,” and other appropriate terminology may be used interchangeably as appropriate without departing from the scope of this disclosure. Moreover, this disclosure contemplates that many users may use one computer (602), or that one user may use multiple computers (602).

In general, the disclosure presented describes using two neural networks to make a prediction when a portion of the input data within the training data contains different data types and/or has different dimensionalities relative to the input data of a task. A first neural network is trained using the training data where some of the training data may not be used. A residual between the output data within the training data and predicted output data from the first neural network are compared to determine at least one residual. The residual and input data within the training data with the same data types and the same dimensionality as the task are used to train a second neural network. The predicted output data from both the first neural network and the second neural network are then combined to predict output data for a task.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

What is claimed is:

1. A method of predicting well performance, comprising:
obtaining first geoscience data and first performance data for a first set of wells, wherein the first geoscience data comprises a first set of data types;
obtaining second geoscience data and second performance data for a second set of wells, wherein the second geoscience data comprises a second set of data types;
obtaining new geoscience data for a new well, wherein the new geoscience data comprises a new set of data types;
training a first neural network using the first geoscience data, a first subset of the second geoscience data, the first performance data, and the second performance data;
determining predicted second performance data using the first neural network;
determining a residual between the second performance data and the predicted second performance data;
training a second neural network using the second geoscience data and the residual;
determining predicted new performance data for the new well by inputting a subset of the new geoscience data into the first neural network;
determining a new residual for the new well by inputting the new geoscience data into the second neural network; and
updating the predicted new performance data using the new residual.

2. The method of claim 1, further comprising:
determining a hydrocarbon field management plan based, at least in part, on the predicted new performance data.

3. The method of claim 1, wherein the first set of wells and the second set of wells are different wells.

4. The method of claim 1, wherein the first set of data types is a second subset of the second set of data types.

5. The method of claim 1, wherein the second set of data types and the new set of data types are a same set.

6. The method of claim 1, wherein the second geoscience data and the new geoscience data each comprise petrophysical data.

7. The method of claim 1, wherein the first performance data, the second performance data, and the predicted second performance data each comprise total cumulative hydrocarbon production over a time window for a well.

8. The method of claim 1, wherein the first neural network and the second neural network each comprise an artificial neural network.

9. The method of claim 1, wherein training the first neural network comprises training the first neural network using the first geoscience data and the first performance data and re-training the first neural network using the first subset of the second geoscience data and the second performance data.

10. A non-transitory computer readable medium storing instructions executable by a computer processor, the instructions comprising functionality for:
receiving first geoscience data and first performance data for a first set of wells, wherein the first geoscience data comprises a first set of data types;
receiving second geoscience data and second performance data for a second set of wells, wherein the second geoscience data comprises a second set of data types;
receiving new geoscience data for a new well, wherein the new geoscience data comprises a new set of data types;
training a first neural network using the first geoscience data, a first subset of the second geoscience data, the first performance data, and the second performance data;
determining predicted second performance data using the first neural network;
determining a residual between the second performance data and the predicted second performance data;
training a second neural network using the second geoscience data and the residual;
determining predicted new performance data for the new well by inputting a subset of the new geoscience data into the first neural network;
determining a new residual for the new well by inputting the new geoscience data into the second neural network; and
updating the predicted new performance data using the new residual.

11. The non-transitory computer readable medium of claim 10, wherein the first set of wells and the second set of wells are different wells.

12. The non-transitory computer readable medium of claim 10, wherein the first set of data types is a second subset of the second set of data types.

13. The non-transitory computer readable medium of claim 10, wherein the second set of data types and the new set of data types are a same set.

14. The non-transitory computer readable medium of claim 10, wherein the second geoscience data and the new geoscience data each comprise petrophysical data.

15. The non-transitory computer readable medium of claim 10, wherein the first performance data, the second performance data, and the predicted second performance data each comprise total cumulative hydrocarbon production over a time window for a well.

16. The non-transitory computer readable medium of claim 10, wherein training the first neural network comprises training the first neural network using the first geoscience data and the first performance data and re-training the first neural network using the first subset of the second geoscience data and the second performance data.

17. A system of predicting well performance, comprising:
a seismic survey system;
a logging system;
a rock core drill bit; and
a computer system configured to:
receive first geoscience data and first performance data for a first set of wells, wherein the first geoscience data comprises a first set of data types,
receive second geoscience data and second performance data for a second set of wells, wherein the second geoscience data comprises a second set of data types,
receive new geoscience data for a new well, wherein the new geoscience data comprises a new set of data types,
train a first neural network using the first geoscience data, a first subset of the second geoscience data, the first performance data, and the second performance data,
determine predicted second performance data using the first neural network,
determine a residual between the second performance data and the predicted second performance data,
train a second neural network using the second geoscience data and the residual,
determine predicted new performance data for the new well by inputting a subset of the new geoscience data into the first neural network,
determine a new residual for the new well by inputting the new geoscience data into the second neural network, and
update the predicted new performance data using the new residual.

18. The system of claim 17, wherein the first set of wells and the second set of wells are different wells.

19. The system of claim 17, wherein the first set of data types is a second subset of the first set of data types.

20. The system of claim 17, wherein the second set of data types and the new set of data types are a same set.
